(19) United States
(12) Patent Application Publication
(10) Pub. No.: US 2013/0151342 A1
(43) Pub. Date: Jun. 13, 2013

(54) ONLINE GAME COMMUNITY WITH CONTROLLED CROSS-PROMOTION

(71) Applicants: Jason CITRON, San Francisco, CA (US); Jakob Wilkenson, San Francisco, CA (US)

(72) Inventors: Jason CITRON, San Francisco, CA (US); Jakob Wilkenson, San Francisco, CA (US)

(73) Assignee: Gree Inc, Tokyo (JP)

(21) Appl. No.: 13/530,067

(22) Filed: Jun. 21, 2012

Related U.S. Application Data
(60) Provisional application No. 61/499,541, filed on Jun. 21, 2011.

(51) Int. Cl. G06Q 30/02

(52) U.S. Cl. CPC G06Q 30/0241
USPC 705/14.64; 705/14.4; 705/14.66

(57) ABSTRACT

A cross-promotion system that controls promotion between video game makers in an online video game community is described. A video game user operates an instance of a video game on a computing device. Information about the operation of the video game and/or the video game user is transmitted to a server of the online cross-promotion system. The online cross-promotion server determines that the maker of the video game is participating is a cross-promotion message, and therefore a cross-promotion message should be displayed within the instance of the video game. The online cross-promotion server can further customize the cross-promote message to increase its relevance to the video game user. The promotion message is transmitted from the online cross-promotion server to the computing device and is displayed within the instance of the video game that is operating on the computing device.

### CROSS-REFERENCE(S) TO RELATED APPLICATION(S)

This application claims priority of U.S. Provisional Application 61/499,541, entitled ONLINE GAME COMMUNITY WITH CONTROLLED CROSS-PROMOTION, filed on Jun. 21, 2011, the entire content of which is incorporated herein by reference.

### BACKGROUND

1. Field

The present disclosure relates generally to online gaming, and more specifically to cross-promotion among video game makers in an online game community.

2. Description of Related Art

Recent improvements in mobile computing and mobile networking technologies have allowed video game makers to produce and market video games that are designed to operate on mobile computing devices and to communicate with online game communities. For example, game makers now make video games that operate on cellular phones and/or tablet computers. In addition, game makers have also leveraged in-game graphical user interface (“GUI”) displays as channels for communication with video game users. For example, video game makers now use in-game GUI displays to promote their products.

The mechanisms that underlie a particular in-game GUI display are typically produced by the marker of the corresponding video game. Since a video game maker is likely to be more interested in promoting its own products (as opposed to a competitor's products), a typical video game maker utilizes its in-game GUI display mechanisms to promote its own products. For at least this reason, conventional in-game GUI displays do not provide a meaningful way for cross-promoting products from different video game makers.

### BRIEF SUMMARY

In some embodiments, an indication that a first video game is running on a first computing device is transmitted to a server. The first computing device is local to a first video game user. The first video game is made by a first game maker. The server transmits a cross-promotion message to the first computing device as necessary. The cross-promotion message promotes a second game maker that has previously promoted, in one of its own video games, the first game maker.

In some embodiments, information about the user of the first computing device is also transmitted to the server. The server instructs the first computing device to prioritize the display of a cross-promotion message based on the identity of the user. For example, a cross-promotion message that references a friend of the user is prioritized for display.

In some embodiments, the server receives information from a second computing device that includes the performance of a second user in a second game that is made by the second game maker. The server may also receive information from the first computing device about the performance of the first user in the first video game. The server produces cross-promotion messages based on performance of one or both of the users. For example, when the server recognizes that one user has achieved a particular game objective while the other user has not achieved the same game objective, the server transmits a cross-promotion message that encourages the latter user to revisit the video game.

### DESCRIPTION OF THE FIGURES

FIG. 1 is a diagram depicting an exemplary use of technologies for controlling cross-promotion of video game makers in an online gaming community (“Online Gaming Cross-Promotion”).

FIG. 2 is a block diagram depicting components in an exemplary Online Gaming Cross-Promotion system.

FIG. 3 is a block diagram depicting an exemplary process of an Online Gaming Cross-Promotion system.

FIG. 4 is a block diagram depicting another exemplary process of an Online Gaming Cross-Promotion system.

FIG. 5 depicts exemplary messages displayed in an Online Gaming Cross-Promotion system.

FIG. 6 depicts exemplary messages displayed in an Online Gaming Cross-Promotion system.

FIG. 7 depicts an exemplary quota system for displaying messages.

FIG. 8 depicts an exemplary computing system for performing Online Gaming Cross-Promotion processes.

FIG. 9 depicts another exemplary computing system for performing Online Gaming Cross-Promotion processes.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

The embodiments described herein include technologies for controlling cross-promotion among video game makers in an online gaming community. Consistent with its plain and ordinary meanings, the term “cross-promotion” refers to the promotion of entity α (and/or its product) by another entity β, and the promotion of the other entity β (and/or its product) by entity α. For example, the promotion of video game maker α's video game in video game maker β's video game, and the promotion of video game maker β's video game in video game maker α's video game constitutes cross-promotion between video game makers α and β. It is important for the entities that participate in a cross-promotion system to fulfill their obligations (i.e., to reciprocate) to one another. Technologies for “controlling” cross-promotion include technologies for enforcing the fulfillment of obligations by the participants of a cross-promotion system.

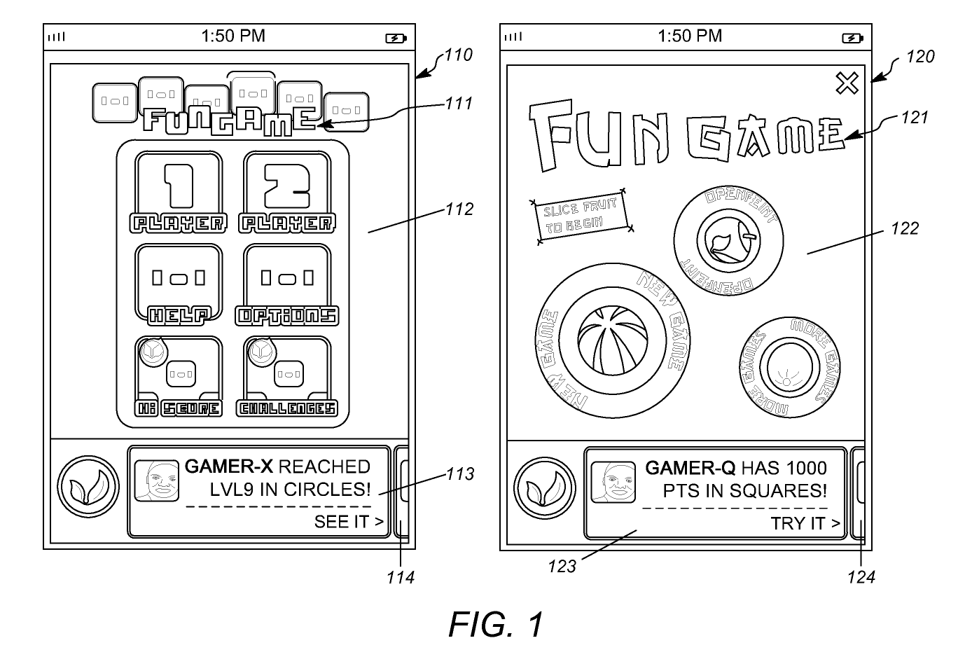

FIG. 1 illustrates an exemplary embodiment of technologies for controlling cross-promotion among video game makers in an online gaming community. For brevity, cross-promotion in this context is hereafter referred to as “Online Gaming Cross-Promotion”. As shown in FIG. 1, display screen 110 includes GUI 112 representing an instance of video game 111. In addition, display screen 120 includes GUI 122 representing an instance of video game 121. Video game GUIs 112 and 122 include cross-promotion messages 113 and 123, respectively. Notably, cross-promotion message 113 (shown in an instance of video game 111) promotes video game 121, and cross-promotion message 123 (shown in an instance of video game 121) promotes video game 111. That is, cross-promotion messages 113 and 123 cross-promote video games 111 and 112. In this way, the makers of video games 111 and 121 can encourage their user community to download and/or to play other video games.

In addition to cross-promotion messages 113 and 123 which are displayed fully, GUIs 112 and 122 also include cross-promotion messages 114 and 124, respectively, which are only displayed partially. A video game user may swipe horizontally on cross-promotion messages 113 and 123 to see other available cross-promotion messages, including cross-promotion messages 114 and 124. In this way, an entire sequence of cross-promotion messages may be readied for access by a video game user. Cross-promotion messages 113 and 123 are considered to have higher display priority over cross-promotion messages 114 and 124, respectively, because cross-promotion messages 113 and 123 precedes cross-promotion messages 114 and 124 in the corresponding sequence of available cross-promotion messages. In addition, a cross-promotion message that appears first in a particular sequence of cross-promotion messages is considered to have the highest display priority, because it is fully displayed to a video game user when a video game becomes loaded and displayed on-screen.

Note, video games 112 and 122 can be made by the same video game maker or can be made by different video game makers. The concept of cross-promotion is more effective, however, when one video game maker can promote its products in the products of another video game maker. Further, although the cross-promotion messages of FIG. 1 are illustrated in portrait layout, it should be appreciated that cross-promotion messages can also be displayed in landscape layouts.

### 1. Exemplary Architecture

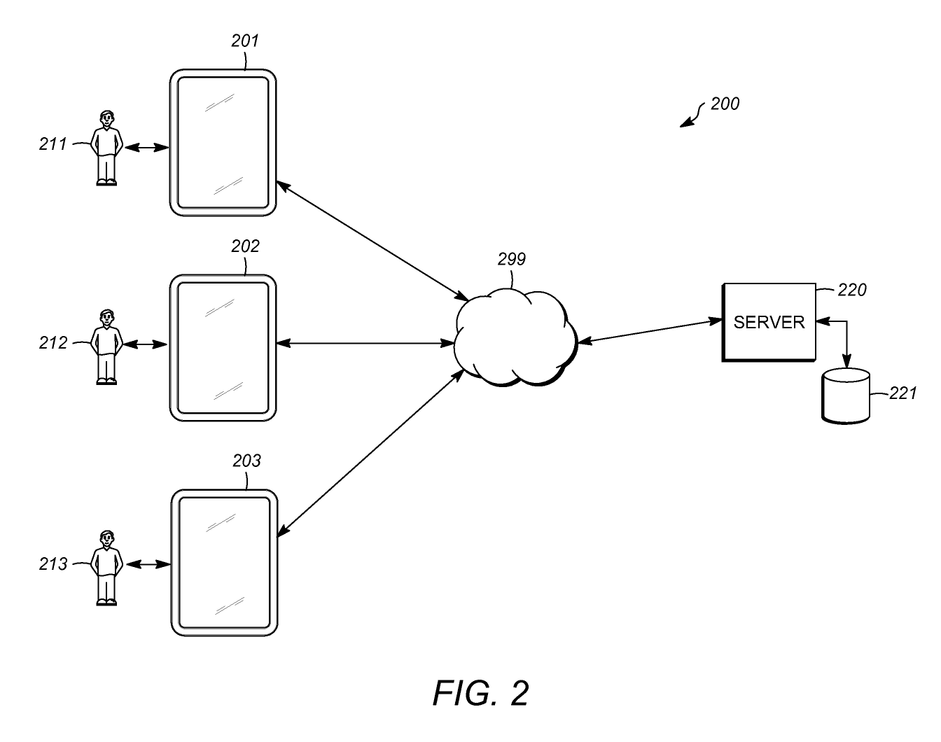

FIG. 2 illustrates an exemplary Online Gaming Cross-Promotion System 200 that can produce the exemplary cross-promotion messages shown in FIG. 1. Exemplary Online Gaming Cross-Promotion System 200 includes Online Gaming Cross-Promotion server 220 and database 221 connected to network 299. Online Gaming Cross-Promotion server 220 includes computer instructions for maintaining cross-promotion messages. Database 221 maintains information about video game users, video games, video game makers, and/or cross-promotion messages of Online Gaming Cross-Promotion System 200. Online Gaming Cross-Promotion System 200 also includes computing devices 201-203 connected to network 299. Computing devices 201-203 are operated by users 211-213, respectively. Computing devices 201-203 are each capable of executing a video game. In some embodiments, computing devices 201-203 are mobile computing devices such as cellular phones and/or tablet computers. In some embodiments, computing devices 201-203 are legacy computing devices such as laptop computers and/or desktop computers.

### 2. Exemplary Process

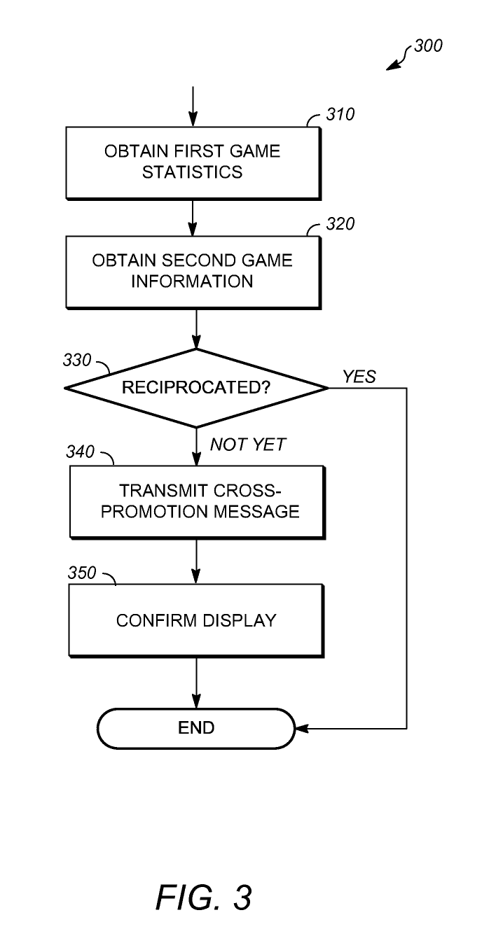

FIG. 3 illustrates exemplary Online Gaming Cross-Promotion process 300 that is performed by components of Online Gaming Cross-Promotion System 200 (FIG. 2) to create, transmit, and/or display cross-promotion messages. At block 310, video game statistics is obtained from a first computing device. The obtained video game statistics is related to the (gaming) activity and/or the performance of a video game user. For example, the video game statistics may indicate a video game score that was achieved by the user, a game level that was reached by the user, the performance of a predetermined sequence of events within a video game by the user, a badge achieved by the user, a game objective achieved by the user, and the like. The video game statistics can also identify the user of the video game, the video game played by the user, and/or the maker of the video game. For purposes of illustration, consider the situation in which video game statistics related to video game A made by video game maker α is obtained from a first computing device at block 310.

At block 320, information regarding a video game that is operating on a second computing device is obtained. The obtained information may also identify the maker of the video game that is operating on the second computing device. In the alternative, the maker of the video game that is operating on the second computing device may be identified using a suitable lookup technique based on the identity of the video game. For purposes of illustration, consider the situation in which information regarding video game B made by video game maker β is obtained from the second computing device at block 320. Note, it is not required for the information that is obtained at block 320 to include video game statistics. Indeed, for purposes of block 320, the obtaining of an indication that an instance of a video game (e.g., video game B) is operating on the second computing device is sufficient. However, as discussed further below, video game statistics may be optionally included in the information that is obtained at block 320.

At block 330, it is determined whether video game makers α and β has each fulfilled its obligations in a cross-promotion relationship between the two video game makers. For example, block 330 can determine whether a cross-promotion message that promotes video game maker β was previously displayed in an instance of video game maker α's video game A. If such a cross-promotion message was previously displayed, then block 330 can further determine whether video game maker β has reciprocated by displaying, in an instance of its video game B, a cross-promotion message that promotes video game maker α. If video game maker β has already reciprocated, then Online Gaming Cross-Promotion process 300 ends. If video game maker β has not yet reciprocated, processing proceeds to block 340, where a cross-promotion message that promotes video game maker α is transmitted to the second computing device for display in the instance of video game maker β's video game B that is operating on the second computing device.

At block 350, an indication is obtained that the transmitted cross-promotion message has been fully displayed on the second computing device. A record is then made that video game maker β has fulfilled its outstanding obligation to reciprocate in the cross-promotion relationship between video game makers α and β. Online Gaming Cross-Promotion process 300 ends after block 350.

Note, in some embodiments, an outstanding obligation to reciprocate can be considered to be fulfilled even if the corresponding transmitted cross-promotion message is substantially, but not fully displayed on a second computing device. A portion of a cross-promotion message may be displayed in response to, for example, a partial swipe input gesture that “drags” only a portion of a lower priority cross-promotion message into the field of view of a display screen. A cross-promotion message is considered to be substantially displayed if a threshold portion of the cross-promotion message is displayed. The threshold percentage may be, for example, 90%, a percentage greater than 50%, or any other suitable percentage.

In addition to the exemplary Online Gaming Cross-Promotion process described in FIG. 3, other techniques for determining the outstanding obligations of video game makers α and β to each other are possible. For example, a running tally of the cross-promotion messages that video game maker α has displayed, in its video games, for video game maker β (and vice versa) can be maintained. Cross-promotion messages for the video game makers can be transmitted based on the running tally. For example, if video game maker α has displayed a greater number of cross-promotion messages for game maker β than game maker β has displayed for game maker α, then cross-promotion messages that promote game maker α should be transmit for display in instances of video games that are made by video game maker β. Further, it should be noted that (two-way) reciprocating relationships may exist between more than two video game makers, and that a (multi-way) reciprocating relationship may involve more than two video game makers.

### 3. Optional User Identity

Because the above-described exemplary processes determine reciprocity based on the identity of video game makers (and not the identity of a user), a user need not log-in to an instance of a video game in order for cross-promotion messages to be displayed in the instance of the video game. However, when information regarding the identity of a video game user (e.g., via a user log-in process) is available, the video game user's identity can be used optionally to provide additional functionalities related to the provision of cross-promotion messages. Information about the identity of a video game user becomes available when a video game user logs-in to an instance of a video game. The identity of a video game user can be derived from user profile information that is associated with the credentials used by the video game user to log-in to a video game.

### Example 1

### Increased Relevance Based on User Identity

Based on information about the identity of a video game user, cross-promotion messages that more relevant to the identified video game user can be displayed to the identified video game user. Relevance may be determined in various ways. For example, information about the gaming activity of friends of the identified video game user can be considered more relevant to the identified video game user. Friendship between video game users can be determined by referencing a social graph. Components of an Online Gaming Cross-Promotion system, such as Online Gaming Cross-Promotion server 220 (FIG. 2), can maintain a social graph of video game users for purposes of determining friendship, among other purposes. In this way, cross-promotion messages that are related to the friends of a particular video game player can be created and be displayed to the particular video game player, thereby encouraging competition and additional video gaming time among video game users.

As another example, information about video game users who have similar (gaming) activities and/or performance to the identified video game user can be considered more relevant to the identified video game user. That is, cross-promotion messages related to the activity and/or performance of other video game users in video games that are owned and/or have been played by a particular video game user can be created and be displayed to the video game player. For instance, information that another video game user is performing slightly better at a video game that is also being played by a particular video game user can be created and be displayed. In this way, video game users can be encouraged to continue to play the particular video game.

### Example 2

### Prioritized Display Based on User Identity

Further, based on information about the identity of a video game user, certain cross-promotion messages can be prioritized for display to the video game user. For example, cross-promotion messages that are related to friends of the video game user can be prioritized for display over cross-promotion messages that are not related to friends of the video game user.

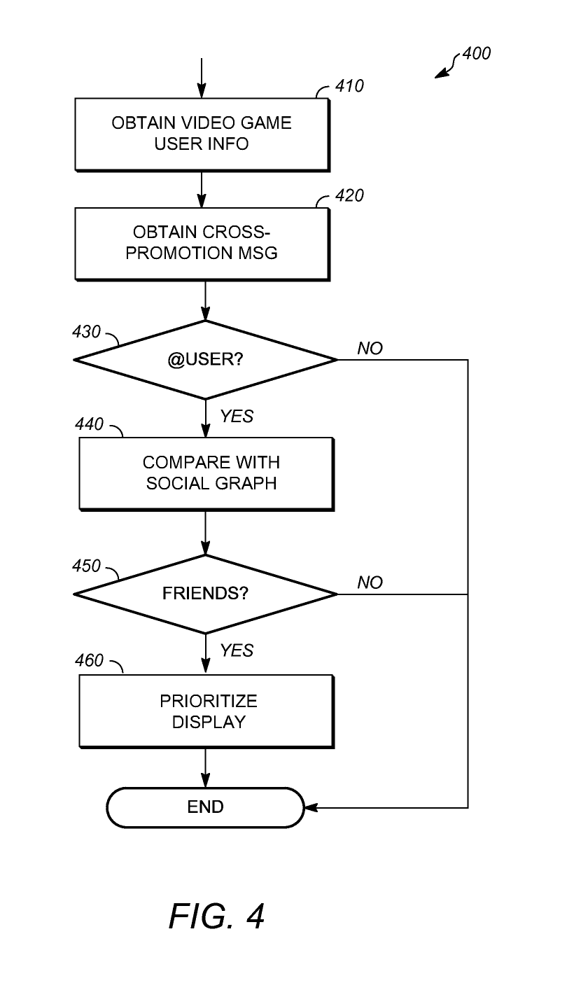

FIG. 4 illustrates exemplary prioritization process 400 that may be performed to prioritize the display of certain cross-promotion messages. At block 410, information about the identity of a video game user who is logged-in to an instance of a video game is obtained. The identity of the video game user can be derived from user profile information that is associated with the credentials that are used by a video game user to log-in to the video game. At block 420, a promotion message is obtained. In some embodiments, block 420 may perform one of more sub-processes of Online Gaming Cross-Promotion process 300 to create a promotion message. At block 430, the subject matter of the obtained cross-promotion message is determined. If the subject matter of the obtained cross-promotion message contains a reference to another video game user, processing proceeds to block 440. If the subject matter does not reference another video game user, then prioritization process 400 ends.

At block 440, the identity of the instant video game user and the identity of the video game user of the subject matter of the obtained cross-promotion message are compared against a social graph. If the two video game users are connected on the social graph, then processing proceeds to block 460, where an instruction to prioritize the display of the cross-promotion message is created. In response to the instruction to prioritize, a computing device prioritizes the display of the cross-promotion message. If the two video game users are not connected on the social graph, then prioritization process 400 ends.

### 4. Exemplary Cross-Promotion Messages

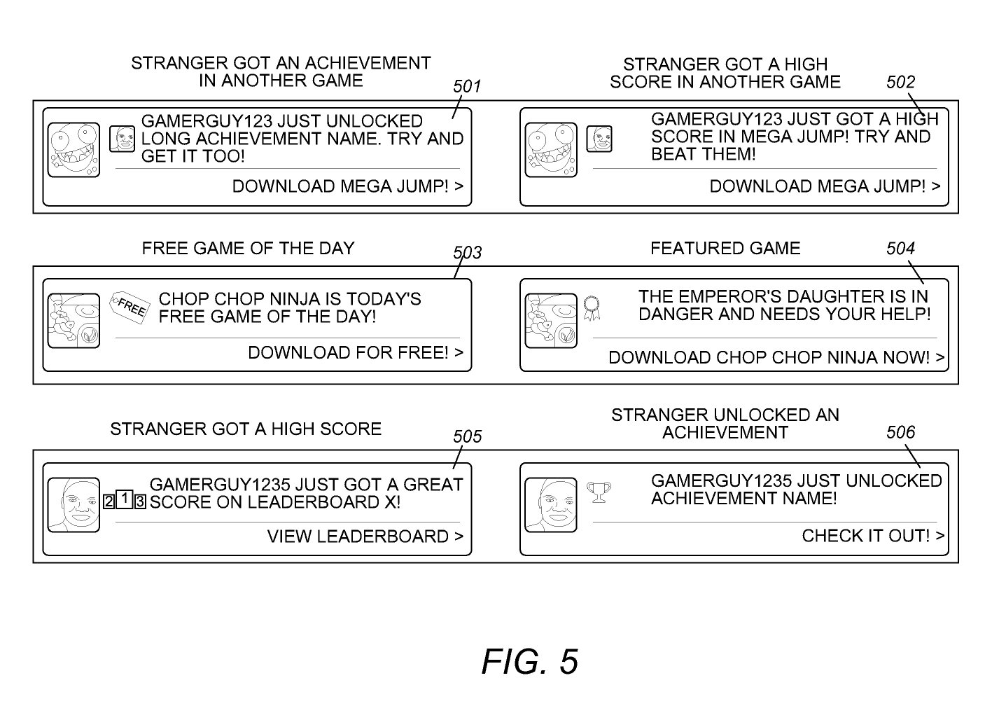

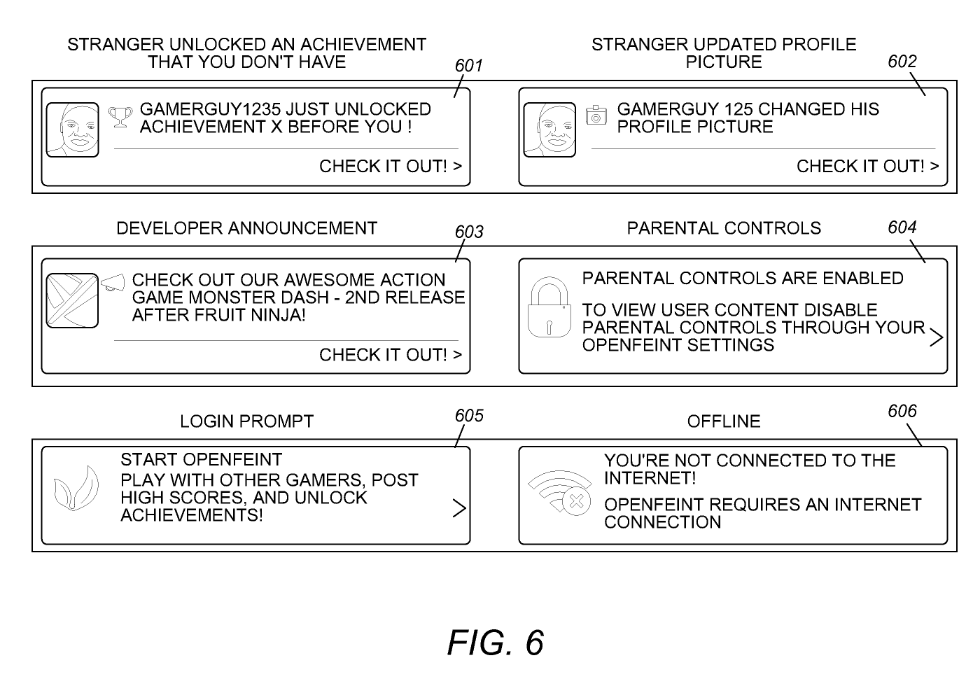

FIGS. 5 and 6 illustrate exemplary cross-promotion messages. Cross-promotion message 501 may be displayed to a video game user when the performance of another video game user in a particular video game exceeds a predetermined threshold. Cross-promotion message 502 may be displayed to a video game user when the performance of another video game user in a particular video game exceeds a certain score. Cross-promotion message 505 may be displayed to a video game user when another video game user is listed on the leaderboard of a video game that is played by both video game users. Cross-promotion message 506 may be displayed to a video game user when the performance of another video game user in the game that is played by both video game users exceeds a predetermined threshold. Cross-promotion message 601 may be displayed to a video game user when another video game user outperforms the video game user in a game that is played by both video game users.

### 5. Additional Messages Types

In some embodiments, messages other than cross-promotion messages may also be created, transmitted, and/or displayed by the components of Online Gaming Cross-Promotion System 200 (FIG. 2). Examples of other types of messages include “House Advertisements”, “Sponsored Stories”, “Developer Announcements”, and “System” messages.

House Advertisement messages contain generic advertisements from a video game maker, and are displayed only in the video games of the video game maker. For example, House Advertisement messages 504 and 603 each contains an advertisement from a video game maker that is intended for the user community of the same video game maker. Sponsored Stories messages are provided by the operator of an Online Gaming Cross-Promotion System. For example, Sponsored Stories message 503 encourages the user community of an Online Gaming Cross-Promotion System to download a sponsored game. An Online Gaming Cross-Promotion System may sponsor a message for a fee. Developer Announcements are messages that are always displayed with the highest priority to a video game user, regardless of other prioritization or reciprocation processes that may be in place. For example, Developer Announcement message 603 indicates the new release of a video game. System messages provide operating status to a video game user. For example, System message 604 indicates that certain video game content is disabled because of parental control settings; System message 605 indicates that an instance of a video game is operating but a video game user has not yet logged into the instance of the video game; and System message 606 indicates that an instance of a video game is operating but the instance of the video game cannot connect to an Online Gaming Cross-Promotion server. A System message is also always displayed to a video game user, but it is not necessarily displayed with the highest priority.

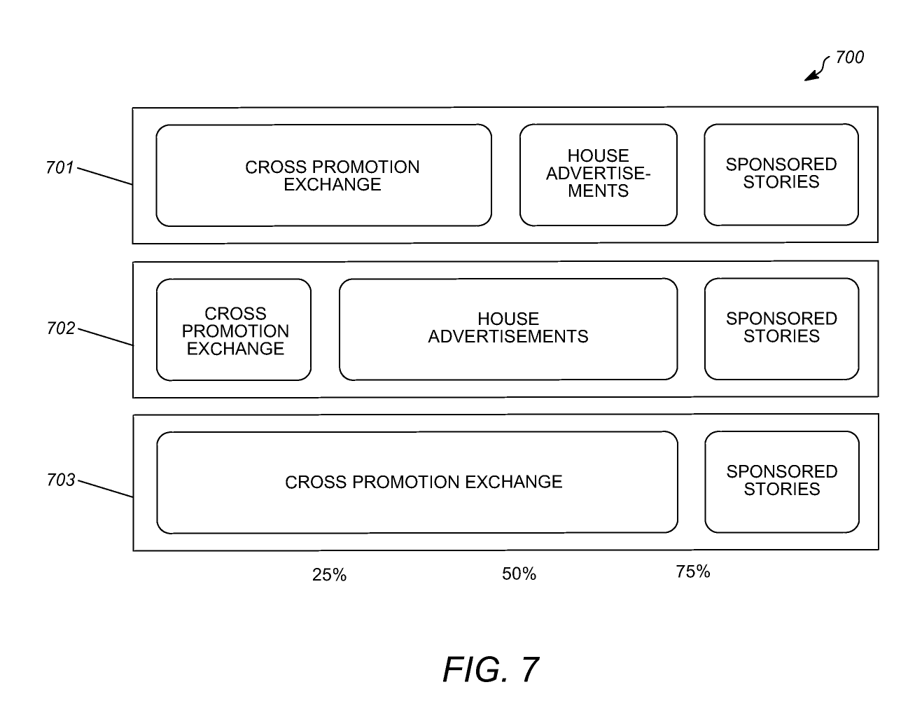

The display of House Advertisements and Sponsored Stories messages are not governed by the above-described processes for cross-promotion, because these types of messages are not considered to be subject to cross-promotion between video game makers. Rather, the display of House Advertisements and Sponsored Stories messages are controlled, by a separate quota system, together with the display of cross-promotion messages. FIG. 7 illustrates an exemplary quota system 700 for governing the display of House Advertisements, Sponsored Stories, and cross-promotion messages. As shown, a video game maker may agree to one of quotas 701-703. For example, under quota 701, 50% of the message that are displayed within the video games of a video game maker are to be cross-promotion messages, 25% of the displayed messages are to be House Advertisement messages from the video game maker, and 25% of the displayed messages are to be Sponsored Stories messages. As shown in FIG. 7, a video game maker must agree to display some amount of Sponsored Stories messages (e.g., 25%) in order to participate in an Online Game Cross-Promotion system. In this way, the operator of an Online Gaming Cross-Promotion server is guaranteed a channel for generating advertising revenue via the displaying of Sponsored Stories messages, especially those containing third-party paid advertisements. Note, in addition to quota system 700, any quota system may be used if it suitably appropriates the display of different types of messages (e.g., House Advertisements, Sponsored Stories, cross-promotions) among the in-game display opportunities provided by a video game maker may be used.

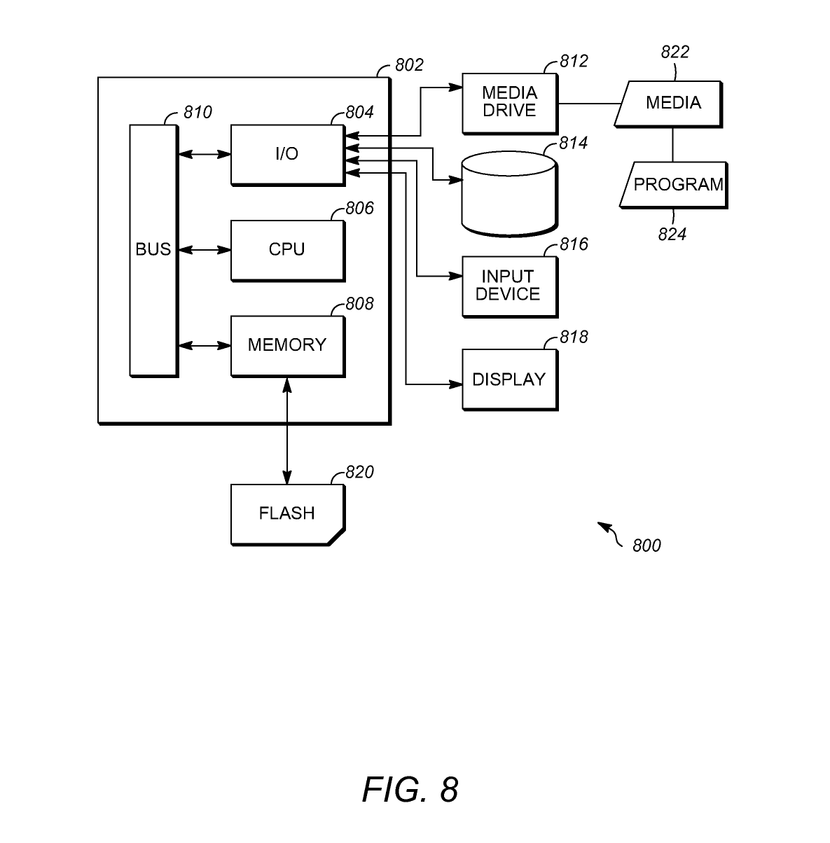

Portions of Online Gaming Cross-Promotion System 200 (FIG. 2) described above may be implemented in exemplary computing system 800. As shown in FIG. 8, computer system 800 includes computer motherboard 802 with bus 810 that connects I/O section 804, one or more central processing units (CPU) 806, and a memory section 808 together. Memory section 808 may have flash memory device 820 related to it. The I/O section 804 may be connected to media drive unit 812, disk storage unit 814, input device 816, and/or display 818. Input device 814 may be a touch-sensitive input device. The media drive unit 812 can read and/or write a computer-readable medium 822, which can contain computer executable instructions 824 and/or data. Computer system 800 may be connected to a network via I/O section 804.

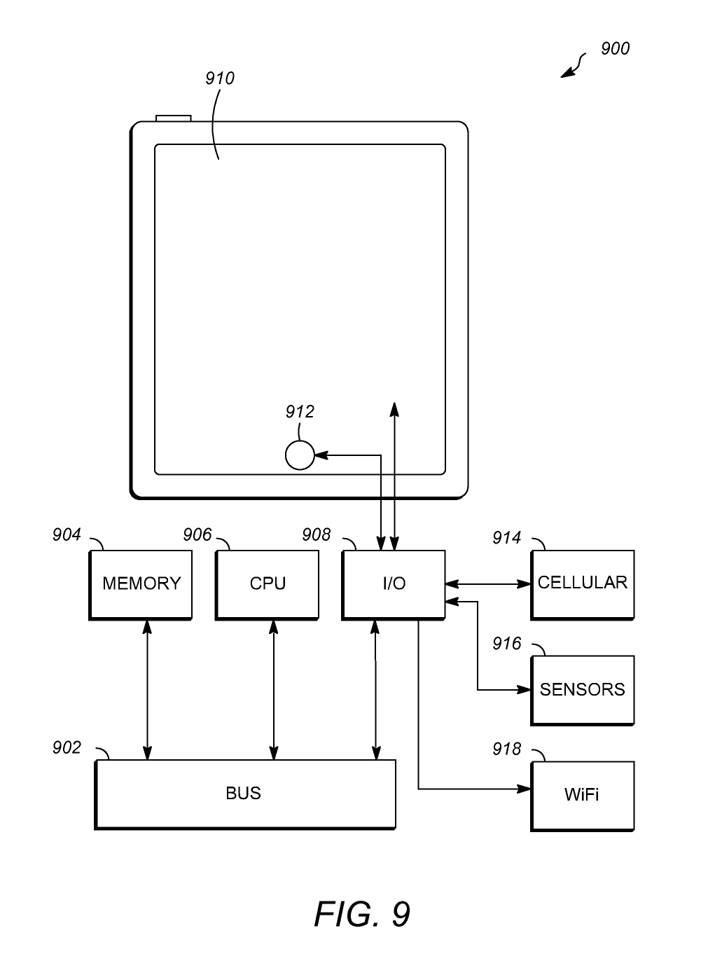

Portions of Online Gaming Cross-Promotion System 200 (FIG. 2) described above also may be implemented in exemplary computing system 900. Computing system 900 may be a cellular phone and/or a tablet computer. As shown in FIG. 9, computing system 900 includes a motherboard with bus 902 that connects memory 904, one or more central processing units (CPU) 906, and I/O unit 908 together. The I/O section 908 may be connected to display 910, input device 912, which may be a touch-sensitive surface, one or more buttons, a keyboard, a mouse, and the like. The I/O section 908 may also be connected to cellular antenna 914, sensors 916, and/or Wi-Fi unit 918. Sensors 916 may include a GPS sensor, a light sensor, a gyroscope, an accelerometer, or a combination thereof.

At least some values based on the results of the above-described processes can be saved into memory such as memory 808, memory 904, disk storage unit 814, flash memory device 820, and/or computer-readable medium 822, for subsequent use. Additionally, computer-readable medium 822 and/or memory 904 can be used to store (e.g., tangibly embody) one or more computer programs for performing any one of the above-described processes by means of a computer. The computer program may be written, for example, in a general-purpose programming language (e.g., C including Objective C, Java, JavaScript including JSON, and/or HTML) or some specialized application-specific language.

Although only certain exemplary embodiments have been described in detail above, those skilled in the art will readily appreciate that many modifications are possible in the exemplary embodiments without materially departing from the novel teachings and advantages of this disclosure. For example, aspects of embodiments disclosed above can be combined in other combinations to form additional embodiments. Accordingly, all such modifications are intended to be included within the scope of this technology.

What is claimed is:

1. A computer-implemented method for controlling the display, on a local computing device, of internet social gaming messages related to a first game maker and a second game maker involving a first message and a second message, the method comprising:
transmitting, to a server, an indication that the first video game is running on the local computing device, wherein the first video game is made by the first game maker; and
receiving, from the server, an instruction to display a second message on the local computing device,
wherein the second message promotes a second game maker,
wherein the second message is received if a first message has been previously transmitted from the server to a remote computing device and has been previously displayed on the remote computing device; and
displaying, on the local computing device, the second message.

2. The method of claim 1, further comprising:
identifying a first user of the first video game; and
transmitting the identity of the first user to the server, wherein:
the second message represents the performance of the second user in the second video game made by the second game maker and whether the first user and the second user are connected in a social graph, and
the displaying of the second message further comprises prioritizing the display of the second message on the local computing device if the first user and the second user are connected in a social graph.

3. The method of claim 2, wherein the social graph is maintained by a social networking server.

4. The method of claim 1, wherein:
the second message indicates the second user has achieved a game score in the second video game made by the second game maker.

5. The method of claim 1, wherein:
the second message indicates the second user has reached a game level in the second video game made by the second game maker.

6. The method of claim 1, wherein:
the second message represents an advertisement for the second game maker.

7. The method of claim 1, wherein:
the first computing device is a mobile phone.

8. The method of claim 1, wherein:
the first computing device is a tablet computer.

9. The method of claim 1, wherein:
the second message is displayed without requiring the first user to log into the first video game.

10. A computer-implemented method for tracking internet social gaming activity, the method comprising:
obtaining, from a first computing device, a first game statistics, wherein the first game statistics are associated with the performance of a first user in a first video game made by a first game maker;
obtaining, from a second computing device, an indication that a second video game is running on the second computing device, wherein the second video game is made by a second game maker;
determining whether a first message regarding the second game maker has been previously transmitted to the first computing device and has been previously displayed on the first computing device; and
if the first message has been previously transmitted and displayed on the first computing device, then transmitting, to the second computing device for display on the second computing device, a second message regarding the first game maker.

11. The method of claim 10, further comprising:
obtaining, from the second computing device, the identity of a second user of the second video game;
determining whether the first user and the second user are connected in a social graph; and
if the first user and the second user are connected in the social graph, instructing the second computing device to prioritize the display of the second message regarding the first game maker.

12. The method of claim 11, further comprising:
connecting to a social networking server; and
determining whether the first user and the second user are connected in the social graph based on the connection to the social networking server.

13. The method of claim 10,
wherein the first game statistic represents a game score achieved by the first user of the first video game, and
wherein the second message indicates that the first user has achieved the game score.

14. The method of claim 10,
wherein the first game statistic is represents game level reached by the first user of the first video game, and
wherein the second message indicates that the first user has achieved the game level.

15. The method of claim 10, wherein the second message represents an advertisement for another video game made by the first game maker.

16. The method of claim 10, wherein the second message represents an advertisement for the first game maker.

17. The method of claim 10, wherein:
the second computing device is a mobile phone.

18. The method of claim 10, wherein:
the second computing device is a tablet computer.

19. The method of claim 10, wherein:
the second message is transmitted without requiring a second user to log into the second video game.

20. A non-transitory computer-readable storage medium having computer-executable instructions for controlling the display, on a local computing device, of internet social gaming messages, the computer-executable instructions comprising instructions for:
transmitting, to a server, an indication that the first video game is running on the local computing device, wherein the first video game is made by the first game maker; and
receiving, from the server, an instruction to display a second message on the local computing device,
wherein the second message promotes a second game maker,
wherein the second message is received if a first message has been previously transmitted from the server to the remote computing device and has been previously displayed on the remote computing device; and
displaying, on the local computing device, the second message.

21. The non-transitory computer-readable storage medium of claim 20, the computer-executable instructions further comprising instructions for:
identifying a first user of the first video game; and
transmitting the identity of the first user to the server, wherein:
the second message represents the performance of the second user in the second video game made by the second game maker and whether the first user and the second user are connected in a social graph, and
the displaying of the second message further comprises prioritizing the display of the second message on the local computing device if the first user and the second user are connected in a social graph.

22. The non-transitory computer-readable storage medium of claim 21, wherein:
the social graph is maintained by a social networking server.

23. The non-transitory computer-readable storage medium of claim 20, wherein:
the second message indicates the second user has achieved a game score in the second video game made by the second game maker.

24. The non-transitory computer-readable storage medium of claim 20, wherein:
the second message indicates the second user has reached a game level in the second video game made by the second game maker.

25. The non-transitory computer-readable storage medium of claim 20, wherein:
the second message represents an advertisement for the second game maker.

26. The non-transitory computer-readable storage medium of claim 20, wherein:
the first computing device is a mobile phone.

27. The non-transitory computer-readable storage medium of claim 20, wherein:
the first computing device is a tablet computer.

28. The non-transitory computer-readable storage medium of claim 20, wherein:
the second message is displayed without requiring the first user to log into the first video game.

29. A non-transitory computer-readable storage medium having computer-executable instructions for tracking internet social gaming activity, the computer-executable instructions comprising instructions for:
obtaining, from a first computing device, a first game statistics, wherein the first game statistics are associated with the performance of a first user in a first video game made by a first game maker;
obtaining, from a second computing device, an indication that a second video game is running on the second computing device, wherein the second video game is made by a second game maker;
determining whether a first message regarding the second game maker has been previously transmitted to the first computing device and has been previously displayed on the first computing device; and
if the first message has been previously transmitted and displayed on the first computing device, then transmitting, to the second computing device for display on the second computing device, a second message regarding the first game maker.

30. The non-transitory computer-readable storage medium of claim 29, the computer-executable instructions further comprising instructions for:
obtaining, from the second computing device, the identity of a second user of the second video game;
determining whether the first user and the second user are connected in a social graph; and
if the first user and the second user are connected in the social graph, instructing the second computing device to prioritize the display of the second message regarding the first game maker.

31. The non-transitory computer-readable storage medium of claim 30, the computer-executable instructions further comprising instructions for:
connecting to a social networking server; and
determining whether the first user and the second user are connected in the social graph based on the connection to the social networking server.

32. The non-transitory computer-readable storage medium of claim 29,
wherein the first game statistic represents a game score achieved by the first user of the first video game, and
wherein the second message indicates that the first user has achieved the game score.

33. The non-transitory computer-readable storage medium of claim 29,
wherein the first game statistic is represents game level reached by the first user of the first video game, and
wherein the second message indicates that the first user has achieved the game level.

34. The non-transitory computer-readable storage medium of claim 29, wherein:
the second message represents an advertisement for another video game made by the first game maker.

35. The non-transitory computer-readable storage medium of claim 29, wherein:
the second message represents an advertisement for the first game maker.

36. The non-transitory computer-readable storage medium of claim 29, wherein:
the second computing device is a mobile phone.

37. The non-transitory computer-readable storage medium of claim 29, wherein:
the second computing device is a tablet computer.

38. The non-transitory computer-readable storage medium of claim 29, wherein:
the second message is transmitted without requiring a second user to log into the second video game.

39. A system for controlling the display of internet social gaming messages related to a first game maker and a second game maker involving a first message and a second message, the system comprising:
a first computing device configured to:
operate a first video game made by the first game maker;
transmit, to a server, an indication that the first video game is operating on the first computing device;
receive, from the server, an instruction to display the first message on the first computing device, wherein the first message promotes the second game maker; and
a server configured to:
obtain, from the first computing device, an indication that the first video game is operating on the first computing device;
obtain, from a second computing device, game statistics, wherein the game statistics are associated with the performance of a user in a second video game made by the second video game maker;
determine whether the second message has been previously transmitted to the second computing device and has been previously displayed on the second computing device, wherein the second message promotes the first game maker; and
if the second message has been previously transmitted and has displayed on the second computing device, then transmitting the first message to the first computing device.

40. A hand-held wireless computing device for displaying internet social gaming messages related to a first game maker and a second game maker involving a first message and a second message, the device comprising:
a wireless transmission unit configured to:
transmit, to a server, an indication that the first video game is running on the hand-held wireless computing device, wherein the first video game is made by the first game maker; and
receive, from the server, an instruction to display a second message on a display unit,
wherein the second message promotes a second game maker, and
wherein the second message is received if a first message has been previously transmitted from the server to another computing device and has been previously displayed on the other computing device; and
a display unit configured to display the second message.

41. A server for tracking internet social gaming activity, the server comprising:
a network interface unit configured to:
obtain, from a first computing device, a first game statistics, wherein the first game statistics are associated with the performance of a first user in a first video game made by a first game maker;
obtain, from a second computing device, an indication that a second video game is running on the second computing device, wherein the second video game is made by a second game maker; and
a processor connected to the network interface, the processor configured to:
determine whether a first message regarding the second game maker has been previously transmitted to the first computing device and has been previously displayed on the first computing device; and
instruct the network interface unit to transmit, to the second computing device for display on the second computing device, a second message regarding the first game maker, if the first message has been previously transmitted and displayed on the first computing device.
